(19) United States
(12) Patent Application Publication
(10) Pub. No.: US 2012/0098643 A1
(43) Pub. Date: Apr. 26, 2012

(54) RFID READING APPARATUS AND A READING AND ASSOCIATION METHOD

(75) Inventor: Andreas GÜNTHER, Bargteheide (DE)

(73) Assignee: SICK AG, Waldkirch (DE)

(21) Appl. No.: 13/278,800

(22) Filed: Oct. 21, 2011

(30) Foreign Application Priority Data
Oct. 25, 2010 (DE) 102010060148.9

(51) Int. Cl. G06K 7/01

(52) U.S. Cl. 340/10.1

(57) ABSTRACT

The invention relates to an RFID reading apparatus arranged stationary at a conveyor device. The RFID information is read in that during a reading procedure a transponder signal is generated for which purpose an RFID information of a frequency in a base band is modulated by back-scatter modulation onto a carrier signal. In accordance with the invention the transmitter unit has two transmitting antennae spaced apart in the conveying direction with the transmitter signal of one transmission antenna representing the in-phase component of the quadrature amplitude modulated transmission signal and the transmitter signal of the other transmission antenna representing the quadrature component of the quadrature amplitude modulated transmission signal so that on transmission of the in-phase and quadrature components these are superimposed in a plane extending transverse to the conveyor device additively to the full quadrature amplitude modulated transmitter signal.

The invention relates to an RFID reading apparatus which is arranged stationary at a conveyor device for the reading of RFID information of an RFID transponder which generates a transponder signal during a reading procedure in which an RFID information of a frequency in a base band is modulated by back-scatter modulation onto a carrier signal, the apparatus having a transmitter unit for the transmission of a quadrature amplitude modulated transmission signal to the transponder and a receiver unit receiving the transponder signal of the RFID transponder and having an evaluation unit which is designed to read out the RFID information from the transponder signal. The invention also relates to a method for the reading and association of an RFID transponder with an object.

The identification of objects and goods in a manner as free of errors as possible is required for the automation of logistic movements. This takes place at identification points above all on a change of the owner of the goods or on a change of the transport means. An automatized identification system is accordingly for example installed at a received goods entrance of a logistic center in order to register ingoing and outgoing goods. This leads to rapid logistic movements which can readily be understood.

Further important applications for automatic identification are logistic distribution centers, for example of parcel delivery services or luggage handling in airports. A customary method for the identification is barcode reading. In this respect the objects that are conveyed such as palettes, packages or cases are provided with a label carrying a barcode which is read with the aid of stationary barcode reader systems and associated with an object, whereby the object is identified.

Attempts have been made for some time to replace the optical sensing by barcode reader by an RFID reader (Radio Frequency Identification reader). In this connection a transponder is attached to the object to be identified instead of a barcode. Such transponders can in principle be active, i.e. have their own energy supply and generate electromagnetic radiation in their own right. In practice, these transponders are less suitable for logistics, because the unit price of such transponders cannot reach the low level required for the mass market as a result of the energy supply. Accordingly, it is mainly passive transponders without their own energy supply that are used. In both cases the transponder is stimulated by electromagnetic radiation of the reading apparatus to radiate the stored information, with passive transponders drawing the energy that is required from the transmitter energy of the reading system.

In addition to the reading out of the information which the transponder or the RFID tag carries, many applications often also require the precise spatial localization of a plurality of transponders distributed in a small space. With the established ultrahigh frequency standard ISO 18000-6 passive transponders are read out by the back-scatter method. The detection range for an antenna is relatively large. Through the antenna characteristic with an aperture angle of ca. 60° and a detection range of at least a few meters it is possible to communicate within several cubic meters with the RFID transponders positioned there. Ambiguities arise insofar as it is not guaranteed that only a single object provided with a transponder is present in this relatively large region. In this connection the individualization, i.e. the association of an RFID reading to a specific transponder is resolved, at least in the standard ISO 18000-6 by the protocol in that in each case only one specific transponder is required to transmit. However, in this respect, it is an open question as to where this transponder is located, in particular with regard to the object to which it belongs.

A restriction of the range of detection by special antenna characteristics or of the range of detection, for example via the transmitted power only conditionally solves the localization problem.

Insofar as the objects provided with the transponders are moved in one direction on a transport belt, the localization is facilitated by this boundary condition. On such conveyor systems it is namely possible to assume a known linear translation over the sensed section of the conveyor system and it is sufficient under this precondition to determine the position of the transponder once at a position which can be determined at a point in time which can be determined.

With customary procedure only a spatial resolution of a few decimeters up to meters is achieved on conveyor systems because of the large range of detection in the translation direction. That is far from satisfactory with modern logistics. Numerous sources of error additionally disturb accuracy such as a variability in the orientation of the transponder, inhomogeneities of the field and, above all, multiple scattering and echoes.

An RFID reading method is known from US 2002/0008656 A1 in which the direction from which the transponder signals come can be determined by means of a plurality of receiving antennae.

In the article “Localization and Tracking of Passive RFID Tags Based on Direction Estimation” by Yimin Zhang and others, published in International Journal of Antennas and Propagation of the Hindawi Publishing Corporation, vol. 2007, article ID 17426 a localization with respect to the reading direction is effected for the special situation of objects on a conveyor belt (DOA, direction of arrival). For this purpose the signal of the transponder is picked up by two antennae and the phase difference between two signals is evaluated. The DOA is then estimated with respect to the multiple measurement and on the assumption of the known linear movement with known speed in a least-mean-square-fit procedure. In this respect, the phase difference is however evaluated in the received base band. Such an evaluation is relatively complicated and slow.

It is thus the object of the invention to improve the association of the RFID information of a transponder (RFID tag) to the associated object.

This object is satisfied in accordance with the invention by an apparatus of the initially named kind which has the special features that the transmitter unit has first and second transmission antennae spaced apart in the conveying direction with the transmitter signal of the first transmission antenna representing an in-phase component (I_{T}) of the quadrature amplitude modulated transmission signal and the transmitter signal of the second transmission antenna representing a quadrature component (Q_{T}) of the quadrature amplitude modulated transmission signal, so that on transmission of the in-phase and quadrature components these are superimposed in a plane extending transverse to the conveyor device additively to the full quadrature amplitude modulated transmitter signal.

The method of the invention, for the reading and association of a transponder to an object conveyed on a conveyor device in a conveying direction, operates by reading RFID information of an RFID transponder with an RFID reading apparatus arranged stationary at the conveyor device, the method comprises the steps of:
transmitting a quadrature amplitude modulated transmitter signal to the transponder with a transmitter unit,
generating a transponder signal during the reading procedure by modulating an RFID information of a frequency in a base band onto a carrier signal by back-scatter modulation,—
receiving the transponder signal with a receiver unit,
reading out the RFID information from the transponder signal received from the receiver unit with an evaluation unit,
wherein
the transmitter unit transmits the quadrature amplitude modulated transmitter signal to the transponder via first and second transmitter antennae spaced apart in the conveying direction, with the transmitter signals of the first transmitter representing the in-phase component of the quadrature amplitude modulated transmitter signal and the transmitter signal of the second transmitter antenna representing the quadrature component of the quadrature amplitude modulated transmitter signal and,
on transmission of the in-phase and quadrature components, these are additively superimposed in a plane extending transverse to the conveying direction to the complete quadrature amplitude modulated transmitter signal.

Thus the RFID reading apparatus in accordance with the invention for the reading of the RFID information of the RFID transponder is arranged stationary at a conveyor device. The RFID information is read in that a transponder signal is generated during a reading procedure for which purpose an RFID information of a frequency in a base band is modulated onto a carrier signal by back-scatter modulation. A transmitter unit transmits a quadrature amplitude modulated transmitter signal, i.e. with in-phase component (I component) and quadrature component (Q component) to the transponder and a receiving unit receives the transponder signal of the RFID transponder. The RFID information is read out of the transponder signal by an evaluation unit. In accordance with the invention the transmitter unit has two transmitter antennae spaced apart in the conveying direction, with the transmitter signal of the one transmitter antenna representing the in-phase component of the quadrature amplitude modulated transmitter signal and the transmitter signal of the other transmitter antenna representing the quadrature component of the quadrature amplitude modulated transmitter signal so that, on transmitting the in-phase and quadrature components, these are superimposed additively to the complete quadrature amplitude modulated transmitter signal in a plane extending transverse to the conveyor device.

The invention does takes a completely new route, namely not to add the I component and the Q component of the quadrature amplitude modulated transmitter signal to the actual transmitter signal but rather to supply the components individually to one transmitter antenna in each case. In this connection, the transmitter antennae are spaced apart in the conveyor direction, preferably with a spacing of λ/2. If the two components are now transmitted then this leads to the superimposition of the transmitted components in specific regions in such a way that only there is the complete quadrature amplitude modulated transmitter signal present. With a spacing of the transmitter antennae of λ/2 the quadrature amplitude modulated transmitter signal which arises in this way lies in a central plane between the two transmitter antennae. Thus only one transponder which lies in the central plane can “understand” the transmitter signal and thus transmit its RFID information with the transponder signal. All other transponders which are also located in the working range of the transmitter antennas “do not understand the transmitter signal” and do not therefore transmit any transponder signal.

Accordingly, a transponder can be localized and associated, namely in that it is now clear that only one transponder in the central plane can transmit its transponder signal so that this transmitting transponder can then be associated with that object which is precisely passing through the central plane. The only precondition for the correct association of the object is that no two transponders may simultaneously be arranged in the central plane. This signifies for the objects that they cannot be conveyed alongside one another. This is, however, as a rule, ensured in conveyor systems in logistics.

Although the invention can basically also be used in other frequency ranges and with other standards, it is preferably assumed that the ultrahigh frequency standard ISO 18000-6/EPC Class 1 Gen 2 is satisfied. Within Europe, the frequency range that is used lies at 866 to 868 MHz corresponding to a wavelength of ca. 34 cm. Naturally the invention also embraces a plurality of channels and other carrier bands so as to satisfy the standards in other countries such as the USA.

The transmitter antennae are preferably arranged at approximately the same transverse spacing to the conveying direction because then the central plane lies approximately perpendicular to the conveying direction which signifies a simple geometrical arrangement and thus a simple association of the transponder to the object. In this manner the evaluation is particularly simple. If the object provided with the transponder is located on a linear conveyor belt, then the localization is already complete on the central plane up to the width of this conveyor belt, which can mainly be ignored in practice. Accordingly, the width of the conveyor belt and the height of the object is mainly not important because one wishes to sort the objects in most applications with respect only to their translation position coordinates.

In a further development of the invention the transponder has an envelope curve demodulator for the demodulation of an envelope curve of the transmitter signal.

In a further development of the invention the evaluation unit is designed to associate the read RFID information with a single object in each case which is conveyed on the conveyor device.

In order that a clean superposition of the I and Q components is achieved in the desired manner in the central plane, the two transmitter antennas and the associated channels in the transmitter unit are identically designed in a further development of the invention. In this case, disturbing electronic phase shifts can be avoided. Should disturbing phase shifts nevertheless arise then provision can be further made that a phase delay member is arranged in at least one channel by means of which the disturbing electronic phase shifts can be compensated or set.

In order to achieve an adjustment of the central plane to precisely a desired direction a reference RFID transponder can be mounted in one embodiment in the central plane.

The invention will be described in more detail by way of example in the following also with respect to further features and advantages with reference to embodiments and to the accompanying drawings. The pictures of the drawing show, in

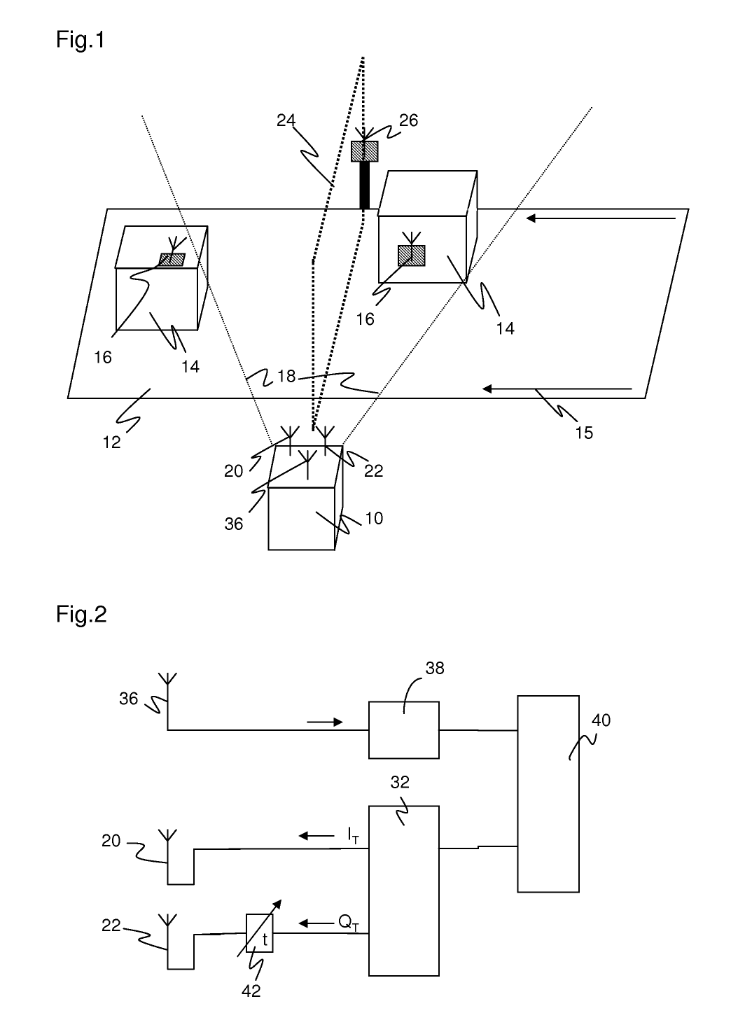

FIG. 1 a schematic three-dimensional representation of an exemplary arrangement of an RFID reading apparatus in accordance with the invention at a conveyor belt which conveys objects provided with transponders and

FIG. 2 a block diagram of the functional units of an embodiment of the RFID reading apparatus in accordance with the invention.

The invention will be described with reference to example of an RFID system in accordance with the UHF standard ISOL 18000-6. The invention is however not restricted to this and can in particular also be used with future standards which have just been developed.

The frequency range which is exploited for the carrier frequency lies at 868 MHz. The communication between the reader and transponder is half duplex, i.e. the transmitter antenna at the transmitter side continually transmit a signal for energy supply but downlink and uplink alternate sequentially with one another. The uplink, i.e. the communication from the transponder to the reader takes place by back-scatter modulation of the transponder and its linearly polarized antenna while the reader transmits a CW signal with known frequency.

In the configuration shown in FIG. 1, an RFID reader 10 is mounted in accordance with this standard or another standard at a conveyor belt 12 which conveys objects 14 in a direction indicated by arrows 15. The objects 14 carry RFID transponders 16 which can be read by the RFID reader 10 when they are located in its reading field 18.

The RFID reader 10 in accordance with the invention has two transmitter antennae 20 and 22 for transmission of a quadrature amplitude modulated transmitter signal, a receiving antenna 36 and a receiving unit 38 for receiving a transponder signal of the RFID transponder 16 and an evaluation unit 40.

Basically the manner of operation of the RFID reader 10 in accordance with the invention is that of a customary RFID reader. The quadrature amplitude modulated transmitter signal is transmitted to a transponder 16 and a transponder signal is then generated in that an RFID information of a frequency in the base band is modulated by back-scatter modulation onto a carrier signal. The transponder signal is received by the receiver antenna 36 and fed to the receiver unit 38 which generates the corresponding signals at the receiver side from the transponder signal and feeds it to the evaluation unit 40. In the evaluation unit 40 the RFID information is read out from these signals.

The novel feature of the invention is that the RFID reader has two transmitter antennae 20 and 22 the spacing of which in the conveyor direction amounts to a maximum of λ/2 and preferably to exactly λ/2 with λ being the wavelength of the base band; at a carrier frequency of 868 MHz, i.e. λ/2=17 cm. The spacing of the two transmitter antennae from the conveyor device 12 transverse to the conveyor direction is the same. The transmitter antennae 20 and 22 are connected to a quadrature modulator 32 which is connected to the evaluation unit 40 which gives the information to be modulated onto this transmitter signal to the quadrature modulator 32. The quadrature modulator 32 correspondingly generates the in-phase component I_{T} of the transmitter signal and the quadrature component Q_{T} of the transmitter signal. These two components are however not added now but rather are respectively fed to an individual one of the transmitter antennae 20 and 22 respectively, so that the transmitter antenna 20 transmits the I_{T} component and the transmitter antenna 22 transmits the Q_{T} component.

Only in the outer space are the I_{T} and Q_{T} components superimposed in the active range of the transmitter antennas 20 and 22. In this connection only in the central plane 24 does it come to such a superimposition that their the complete quadrature amplitude modulated transmitter signal arises there since the two transmitter antennae 20 and 22 have precisely a half wavelength spacing from one another. Only in the central plane do the I_{T} and Q_{T} components have the correct phase relationship to one another in order to form the quadrature amplitude modulated complete transmitter signal.

Since a transponder 16 can only then “understand” the transmitter signal when this is complete and otherwise has no distortions or disturbances, the transponder 16 is only then addressed by the transmitter signal, when it is located in the central plane 24. In this respect it is conceivable that the central plane can have a certain extent which is supposed to mean, for example with a higher transmitter power, that a transponder 16 can also then respond, when it is not lying exactly at the center. A so addressed transponder 16 can then transmit its own transponder signal, so that, when a transponder signal is received by the RFID reader 10, the RFID reader 10 “knows” that this transponder is located in the central plane 24 and thus can be associated with the object instantaneously located there. Since a localization in the conveying direction 15 is sufficient, a precise association of the transponder 16 to the object 14 is possible by way of the invention.

So that the I and Q components are transmitted with the correct phase relative to one another at the transmitter side, the two transmitter channels should be identically formed in order to avoid disturbing electronic phase shifts. Should disturbing phase shifts nevertheless occur, then in one embodiment of the invention a phase delay member 42 can be arranged in one of the two channels or in both channels.

A reference transponder 26 can also be mounted in the central plane 24 at the conveyor belt 12 and it would be conceivable to align the center plane 24 by means of reference transponder 26 in that, for example, the phase delay member 42 is so set that the central plane 24 meets the reference transponder 26, this thus responds.

1. An RFID reading apparatus (10) which is arranged stationary at a conveyor device (12) for the reading of RFID information of an RFID transponder (16) which generates a transponder signal during a reading procedure in which an RFID information of a frequency in a base band is modulated by back-scatter modulation onto a carrier signal, the apparatus includes a transmitter unit for the transmission of a quadrature amplitude modulated transmission signal to the transponder (16), a receiver unit receiving the transponder signal of the RFID transponder (16) and an evaluation unit (40) which is designed to read out the RFID information from the transponder signal, the transmitter unit has first and second transmission antennae (20, 22) spaced apart in the conveying direction with the transmitter signal of the first transmission antenna (20) representing an in-phase component (I_{T}) of the quadrature amplitude modulated transmission signal and the transmitter signal of the second transmission antenna (22) representing a quadrature component (Q_{T}) of the quadrature amplitude modulated transmission signal, so that on transmission of the in-phase and quadrature components these are superimposed in a plane (24) extending transverse to the conveyor device (12) additively to the full quadrature amplitude modulated transmitter signal.

2. An RFID reading apparatus in accordance with claim 1, wherein a spacing of the transmission antennae in the conveying direction amounts to λ/2 where λ is the wavelength of the base band.

3. An RFID reading apparatus in accordance with claim 1, wherein the transmitter antennae are arranged at approximately the same transverse spacing to the conveying direction.

4. An RFID reading apparatus in accordance with claim 1, wherein the transponder has an envelope curve demodulator for the demodulation of an envelope curve of the transmitter signal.

5. An RFID reading apparatus in accordance with claim 1, wherein the evaluation unit is designed to associate the read RFID information in each case to one individual object which is conveyed on the conveyor device.

6. An RFID reading apparatus in accordance with claim 1, wherein the first and second antennae have respectively associated first and second channels and the first and second antennae and their associated channels are identically designed in the transmitter unit in order to avoid disturbing electronic phase shifts.

7. An RFID reading apparatus in accordance with claim 1, wherein the first and second antennae have respectively associated first and second channels and wherein a phase delay member is provided in at least one of said first and second channels by means of which disturbing electronic phase shifts can be compensated or set.

8. An RFID reading apparatus in accordance with claim 6, wherein the phase difference is electronically so set that the additive superimposition of the I and Q components to the complete quadrature amplitude modulated transmitter signal takes place directly on the central plane between the two transmitter antennae.

9. An RFID reading apparatus in accordance with claim 7, wherein the phase difference is electronically so set that the additive superimposition of the I and Q components to the complete quadrature amplitude modulated transmitter signal takes place directly on the central plane between the two transmitter antennae.

10. An RFID reading apparatus in accordance with claim 1, wherein a reference RFID transponder is mounted in the said plane.

11. A method for the reading and association of a transponder to an object conveyed on a conveyor device in a conveying direction by reading RFID information of the RFID transponder with an RFID reading apparatus arranged stationary at the conveyor device, the method comprising the steps of:
transmitting a quadrature amplitude modulated transmitter signal to the transponder with a transmitter unit,
generating a transponder signal during the reading procedure by modulating an RFID information of a frequency in a base band onto a carrier signal by back-scatter modulation,—receiving the transponder signal with a receiver unit,
reading out the RFID information from the transponder signal received from the receiver unit with an evaluation unit,
wherein
the transmitter unit transmits the quadrature amplitude modulated transmitter signal to the transponder via first and second transmitter antennae spaced apart in the conveying direction, with the transmitter signals of the first transmitter representing the in-phase component of the quadrature amplitude modulated transmitter signal and the transmitter signal of the second transmitter antenna representing the quadrature component of the quadrature amplitude modulated transmitter signal and,
on transmission of the in-phase and quadrature components, these are additively superimposed in a plane extending trans-verse to the conveying direction to the complete quadrature amplitude modulated transmitter signal.

12. A method in accordance with claim 11, wherein the relative phase position of the in-phase signal and the quadrature signal can be changed in order to compensate or to set system caused phase differences.
